(19) United States
(12) Patent Application Publication
(10) Pub. No.: US 2022/0284454 A1
(43) Pub. Date: Sep. 8, 2022

(54) CRYPTOCURRENCY VALUATION BY PROCESSING NEAR REAL-TIME AND HISTORICAL DATA FROM MULTIPLE CRYPTOCURRENCY EXCHANGES

(71) Applicant: LUKKA, INC., Naples, FL (US)

(72) Inventors: Eyal Beigman, New York, NY (US); Gerard Brennan, New York, NY (US)

(21) Appl. No.: 17/636,760

(22) PCT Filed: Aug. 18, 2020
(86) PCT No.: PCT/US2020/046849

§ 371 Date: Feb. 18, 2022

Related U.S. Application Data
(60) Provisional application No. 62/889,144, filed on Aug. 20, 2019.

(51) Int. Cl. G06Q 30/02; G06Q 40/04; G06Q 40/00

(52) U.S. Cl. CPC G06Q 30/0201; G06Q 40/04; G06Q 40/123

(57) ABSTRACT

Systems and methods for cryptocurrency valuation by processing near real-time and historical data from multiple cryptocurrency exchanges. An example method comprises: assigning, to each exchange of a plurality of exchanges trading in a specified cryptocurrency, a Base Exchange Score (BES) reflecting one or more characteristics of the exchange; computing, for each exchange of the plurality of exchanges, a Volume Adjusted Score (VAS) by adjusting the BES based on a relative volume of transactions serviced by the exchange during a predefined period of time; computing, for each exchange of the plurality of exchanges, a Decayed Volume Adjusted Score (DVAS) by adjusting the VAS of the exchange to reflect a period of time passed since a most recent transaction performed on the exchange with respect to the specified cryptocurrency; ranking the plurality of exchanges by their respective DVAS scores; designating an exchange associated with a highest value of the DVAS as a principal market for the specified cryptocurrency at a specified point in time; and designate a price of a most recent transaction on the principal market as representing a fair value of the specified cryptocurrency at the specified point in time.

### TECHNICAL FIELD

The present disclosure is generally related to computing systems, and is specifically related to methods and systems for cryptocurrency valuation by processing near real-time and historical data from multiple cryptocurrency exchanges.

### BACKGROUND

“Cryptocurrency” herein shall refer to is a digital asset utilized as means of exchange; a typical cryptocurrency employs strong cryptography to control creation of new cryptocurrency units and validate exchange transactions.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example method 100 of cryptocurrency valuation by processing near real-time and historical data from multiple cryptocurrency exchanges, in accordance with one or more aspects of the present disclosure;

FIG. 2 shows a table that lists the Basic Exchange Score (BES) measures for an example market, in accordance with one or more aspects of the present disclosure;

FIG. 3 shows a table that lists relative transaction volumes for the exchanges of the example market, in accordance with one or more aspects of the present disclosure;

FIG. 4 schematically shows example data utilized for tracking the most recent trades on the exchanges of the example market, in accordance with one or more aspects of the present disclosure;

FIG. 5 shows graphs that schematically illustrate the DVAS scores for each of the four exchanges within the specified period of time, in accordance with one or more aspects of the present disclosure;

FIG. 6 shows example data for designating the principal market, in accordance with one or more aspects of the present disclosure;

FIG. 7 shows example data for identifying the spot price to serve as the fair value of the cryptocurrency, in accordance with one or more aspects of the present disclosure; and

FIG. 8 schematically illustrates a component diagram of an example computing system operating in accordance with one or more aspects of the present disclosure.

### DETAILED DESCRIPTION

Described herein are systems and methods for cryptocurrency valuation by processing near real-time and historical data from multiple cryptocurrency exchanges.

Cryptocurrencies and their foundational cryptographically-protected distributed ledger technologies are evolving rapidly. The rapid technological development has been opening new horizons to various cryptocurrency uses and applications; however, cryptocurrency as an economic phenomenon is not yet well understood. Unique characteristics of the cryptocurrency markets, such as high levels of fragmentation, difference in local rules, lack of effective arbitrage, inadequate transparency, unknown reliability of the data published by the exchange, etc., contribute to high volatility and significant differences in prices among multiple exchanges, thus posing significant theoretical, organizational, and technological challenges for cryptocurrency holders in classification and measurement of cryptocurrencies, as well as other accounting and reporting tasks. Furthermore, large amounts of data produced by the segmented exchanges and market participants may contribute to significant technological challenges, by requiring high computational capacity and high throughput/low latency communication channels for near real-time data processing.

Various valuation techniques may utilize spot prices from the principal market, which is the market with the greatest volume and level of activity for the asset. However, as noted herein above, one of the key characteristics of the cryptocurrency market is its high level of fragmentation. For example, two well-known cryptocurrencies, Bitcoin and Ethereum, are traded on over 100 exchanges worldwide utilizing a large variety of underlying trading mechanisms. Thus, the possibility exists that there may be no single exchange that is dominant in terms of volume, price discovery, or any other attribute that would make it an obvious principal market.

Moreover, due to the difference in trading rules, and/or to the lack of active arbitrageurs at the current phase of market development for many exchanges, there can be significant differences in the prices between the exchanges, and due to geographic disparity, a constant shift in the volume occurs throughout the day.

The present disclosure address these and other challenges by introducing novel and efficient computer-based systems and computer-implemented methods that exploit a fair value model adapted to the context and requirements of the cryptocurrency market.

The systems and methods of the present disclosure extract a fair value of a given cryptocurrency from a principal market, which is identified based on a weighting scheme that assigns and adjusts scores of each exchange based on the level of exchange oversight, the microstructure efficiency, transparency and data integrity, transaction volume, and the time lag between trades. The computations may be performed in near real-time, thus at each point in time reflecting the latest set of data received from the respective exchange, as described in more detail herein below.

The systems and methods described herein may be implemented by hardware (e.g., general purpose and/or specialized processing devices, and/or other devices and associated circuitry), software (e.g., instructions executable by a processing device), or a combination thereof. Various aspects of the above referenced methods and systems are described in detail herein below by way of examples, rather than by way of limitation.

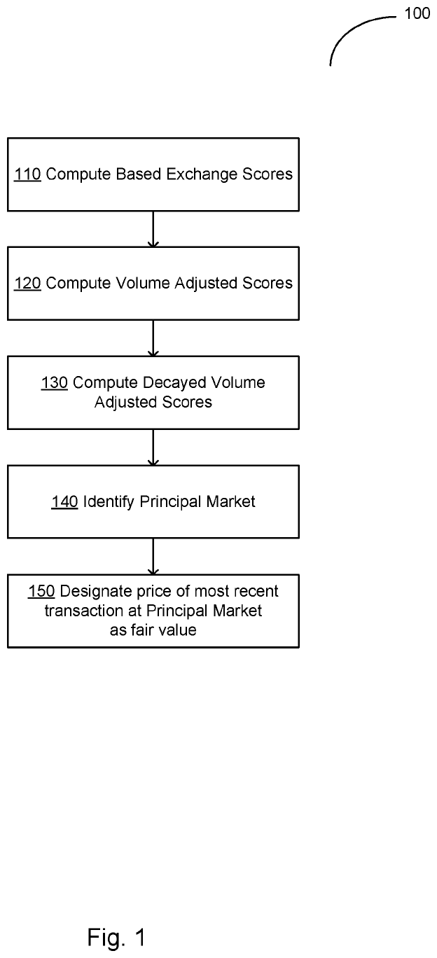

FIG. 1 schematically illustrates an example method 100 of cryptocurrency valuation by processing near real-time and historical data from multiple cryptocurrency exchanges, in accordance with one or more aspects of the present disclosure. The fair value may be expressed in another cryptocurrency or in a chosen fiat currency. The example method 100 extract a fair value of a given cryptocurrency from a principal market, which is identified based on a weighting scheme that assigns and adjusts scores of each exchange based on the level of exchange oversight, the microstructure efficiency, transparency and data integrity, transaction volume, and the time lag between trades.

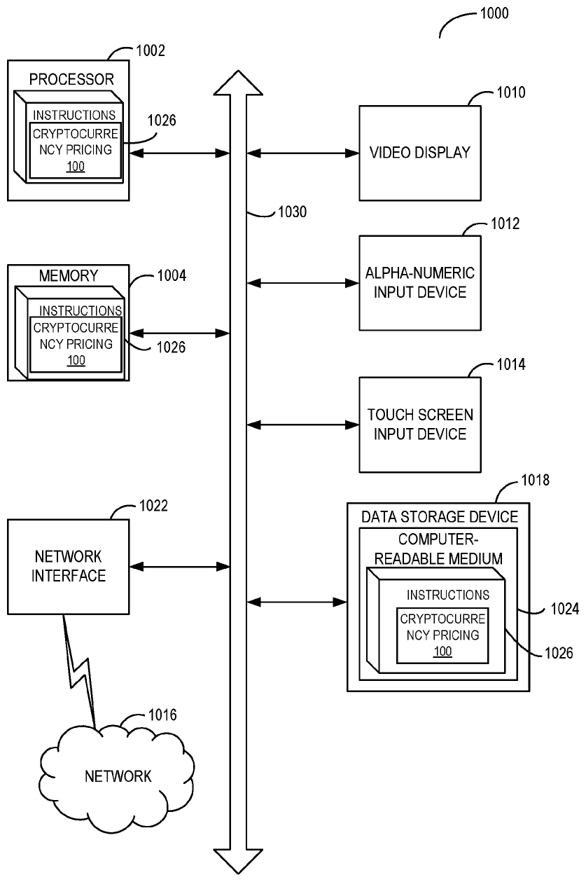

Method 100 and/or each of its individual functions, routines, subroutines, or operations may be performed by one or more processors of a computing system (e.g., the example computing system 1000 of FIG. 8) implementing the method. In certain implementations, method 100 may be performed by a single processing thread. Alternatively, method 100 may be performed by two or more processing threads, each thread executing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other.

At operation 110, the computing system implementing the method assigns, to each exchange that trades in the specified cryptocurrency, a Base Exchange Score (BES) for the specified cryptocurrency. The BES may reflect various characteristics, including, e.g., the exchange oversight, the microstructure efficiency of the exchange, the data transparency of the exchange, and the data integrity of the exchange.

The exchange oversight reflects the regulations and rules applicable to the exchange based on its jurisdiction (e.g., “Know Your Customer and Anti-Money Laundering Compliance” (KYC/AML) rules). In an illustrative example, the exchange oversight may be characterized by the score assigned to the jurisdiction of the exchange based on a predefined hierarchy of the jurisdictions, such that a Level 1 jurisdiction (having the maximum level of oversight among the jurisdictions that are being considered) is assigned a score of 100 and that score is reduced by 20 points for each subsequent level.

The microstructure efficiency of the exchange may be characterized, e.g., by the effective bid-ask spread. Accordingly, the microstructure efficiency score for the exchange i=0, . . . , n is computed as:

$${s}_{i}^{eff} = 100 * \frac{{sp}_{i} - {min}_{j} ( {sp}_{j} )}{{max}_{j} ( {sp}_{j} ) - {min}_{j} ( {sp}_{j} )}$$

where spᵢ denotes the spread of the i-th exchanges measured as shares (e.g., 1/10,000) of the asset price.

The data transparency of the exchange reflects the level of detail of the data provided by the exchange. In an illustrative example, the data transparency may be characterized by the scores that are assigned to each level of detail based on a predefined hierarchy, such that an exchange providing Level 1 level of detail (i.e., the maximum level of detail among the exchanges that are being considered) is assigned a score of 100 and that score is reduced by 20 points for each subsequent level. An example hierarchy of the level of detail of the data provided by the exchange includes: orders (the maximum score), order book, trades, candlestick charts, and no data (the minimum score).

The data integrity of the exchange may reflect the impact of various factors, including order reconstruction, minute volume matching, and daily volume matching. In an illustrative example, the data integrity may be evaluated on three-time scales: on tick level, short term (minutes), and daily, with the following scores:

s_{ord}—order reconstruction

sₘᵢₙᵤₜₑ—minute volume matching

s_{day}—daily volume matching.

The order reconstruction reflects the ability of a third party to identify, based on the information provided by the exchange, all transactions (including cancellations) that where completed as part of a specific order. Accordingly, the order reconstruction score may be computed as follows:

s_{ord}=100*(1−e^{-vp}^{_{ord}}) for v>0

where p_{ord}>0 is the volume weighted fraction of reconstructed orders.

The minute volume matching score can be computed as follows:

sₘᵢₙᵤₜₑ=100*(1−e^{-vp}^{ₘᵢₙ}) for v>0

where pₘᵢₙ>0 is the fraction of the volume on the time bar accounted by individual trades.

The daily volume matching may be determined similarly to the minute volume matching, by substituting the daily volume for the minute volume.

The data integrity score may be computed as a weighted average of these scores:

s^{int}=w_{ord}s_{ord}+wₘᵢₙᵤₜₑsₘᵢₙᵤₜₑ+w_{day}s_{day}

The weights w_{ord}, wₘᵢₙᵤₜₑ, and w_{day} are based on the relative importance of each factor at a point in time as assessed by the entity.

Thus, the BES is determined by computing an aggregate function (e.g., a weighted average) of the individual values reflecting the chosen characteristics of the exchange:

sₑₓ_{ᵢ}^{BES}=wₒᵥsₑₓ_{ᵢ}^{ov}+w_{eff}sₑₓ_{ᵢ}^{eff}+wₜᵣₐₙsₑₓ_{ᵢ}^{tran}+wᵢₙₜsₑₓ_{ᵢ}^{int}

where sₑₓ_{ᵢ}^{ov} is the oversight score for the i-the exchange,

sₑₓ_{ᵢ}^{eff} is the efficiency score for the i-the exchange,

sₑₓ_{ᵢ}^{tran} is the data transparency oversight score for the i-the exchange, and

sₑₓ_{ᵢ}^{int} is the integrity score for the i-th exchange.

w are the weight coefficients that are based on the relative importance of each factor for the overall quality of the exchange. For example, it is likely that oversight and efficiency would be accorded more weight than transparency and data integrity.

Referring again to FIG. 1, at operation 120, the computing system computes, for each exchange, its Volume Adjusted Score (VAS). The VAS is computed by adjusting the BES based on the relative volume of transactions in the specified asset that have been serviced by this exchange over a predefined period of time:

$${s}_{{ex}_{i}}^{V A S} = \frac{v o {l}_{{ex}_{i}}}{{\sum }_{j} v o {l}_{{ex}_{j}}} {s}_{{ex}_{i}}^{B E S}$$

where volₑₓ_{ᵢ} is the relative volume of transactions that have been serviced by the i-th exchange over a predefined period of time (e.g., a reporting period).

In an illustrative example, the BES for a given exchange may be multiplied by the ratio of the volume of transactions in the specified asset that have been serviced by this exchange over the predefined period of time to the total volume of transactions in the specified asset that have been serviced by all known exchanges over the predefined period of time (e.g., within a year ending on a specified date).

Referring again to FIG. 1, at operation 130, the computing system computes, for each exchange, Decayed Volume Adjusted Score (DVAS). The DVAS is computed by adjusting the VAS based on the time passed since the most recent trade on the exchange, thus assessing the level of activity in the exchange by considering the frequency of trades. In other words, the decay factor, which reflects the time since the most recent trade on the exchange, decreases the Volume Adjusted Score of the exchange as the frequency of trades increases (or as time passes since the last trade).

Accordingly, the DVAS for the i-th exchange at time T may be computed as follows:

$${s}_{T , {ex}_{i}}^{D V A S} = {e}^{- \vert T - {t}_{e x} \vert} {s}_{e {x}_{i}}^{VAS}$$

where

$$\{ {p}_{t}^{e {x}_{i}} : t > 0 \}$$

is the time series of prices provided by the i-th exchange, and

$${t}_{{ex}_{i}} = max \{ 0 < t < T : \{ {p}_{τ}^{{ex}_{i}} : t < τ < T \} \neq ∅ \}$$

is the timestamp on the most recent trade coming from the i-th exchange.

Referring again to FIG. 1, at operation 140, the computing system ranks the exchanges by their respective DVAS scores and designates the highest-ranking exchange as the Principal Market for the specified cryptocurrency:

$$e {x}^{principal} = arg max \{ {s}_{T , {ex}_{i}}^{DVAS} : {ex}_{1} , … , {ex}_{n} )$$

The Principal market designation is associated with a certain point in time (denoted T), e.g., the end of a reporting period. In an illustrative example, the point in time T may fall within the period of time that was utilized for aggregating transaction volumes in computing the VAS at operation 120. In another illustrative example, the point in time T may match the end of the period of time that was utilized for aggregating transaction volumes in computing the VAS at operation 120.

Referring again to FIG. 1, at operation 150, the computing system designates the price of the most recent transaction on the principal market as the fair value for the specified cryptocurrency for the chosen point in time T:

$${p}_{T}^{fair} = {p}_{{t}_{e {x}^{principal}}}^{e {x}^{principal}}$$

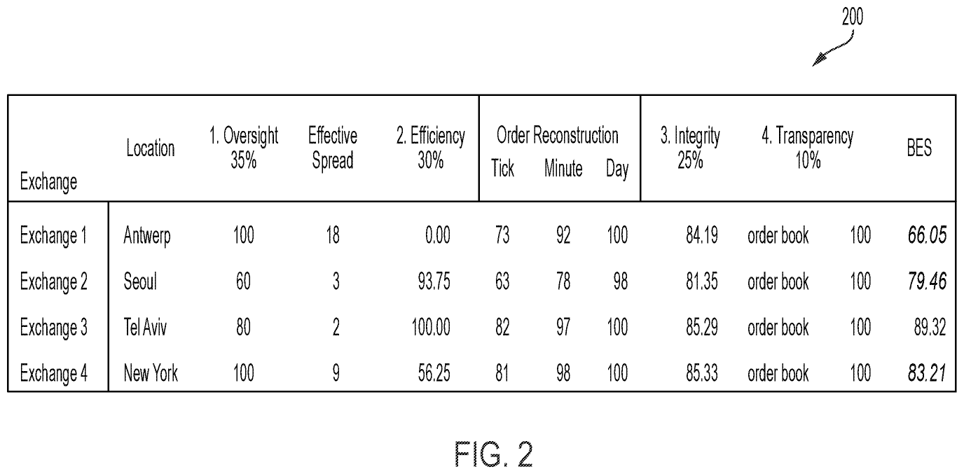

An example of identifying a principal exchange and assigning a fair value to a cryptocurrency, in accordance with aspects of the present disclosure is described below with references to FIGS. 2-7. In the below example, all exchange names, currency designation, numbers, and scores are utilized for illustrative purposes only.

The example identifies the principal market and determines a spot price of a given cryptocurrency at the end of a specified period. FIG. 2 shows table 200 that provides the BES scores for the example market that consists of four exchanges. The BES is the weighted average of the four, key exchange characteristics: Oversight, Efficiency, Data Integrity and Transparency. The weights used in this computation are noted in the respective column headings of table 200. In this example, the BES for Exchange 1 would be computed as follows:

BES Exchange₁=(35%×100)+(30%×0)+(25%*84.19)+(10%*100)=66.05

BES scores for Exchanges 2-4 may be computed using similar techniques.

Notably, due to the computational complexity caused inter alia by the amount of raw data to be received and processed (e.g., for evaluating the microstructure efficiency), computing the relative BES scores requires high-performance computing systems and high-throughput/low latency communication channels that are capable of facilitating near real-time computations.

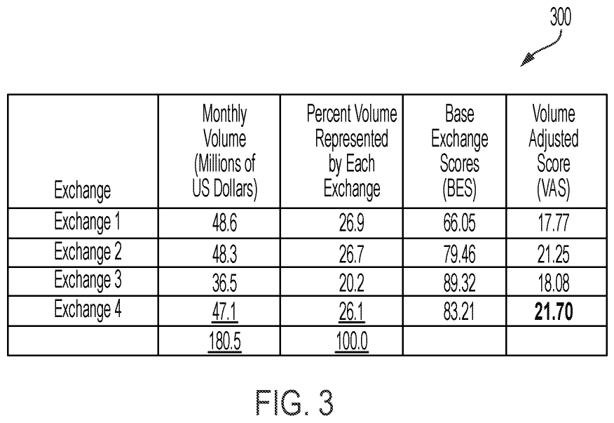

The computed BES scores are then adjusted based on the relative monthly transaction volume serviced by the respective exchange. This new score is the Volume Adjusted Score (VAS). Notably, due to the computational complexity caused inter alia by the amount of raw data to be received and processed, computing the relative transaction volumes serviced by each exchange requires high-performance computing systems and high-throughput/low latency communication channels that are capable of facilitating near real-time computations. In the present example, the relative transaction volumes are assumed to be equal to the values shown in table 300 of FIG. 3.

In this example, the VAS for Exchange 1 would be computed as follows:

VAS_{Exchange}_{₁}=(% Volume×BES)=(26.9%*66.05)=17.77

VAS scores for Exchanges 2-4 may be computed using similar techniques.

Accordingly, the volume adjusted BES amounts for sample exchanges are presented in table 300 of FIG. 3. As shown in table 300, Exchange 4 has the highest VAS at 21.70. This illustrates the fact that an exchange with a higher BES can be less dominant due to lower volume. In this case, the principal exchange shifted from Exchange 3 to Exchange 4. However, the VAS score is to be further adjusted for the potential decay or time lag between trades. The decayed volume adjusted scores or DVAS are computed based on the time passed since the most recent trade on the respective exchange, thus assessing the level of activity in the exchange by the frequency of trades.

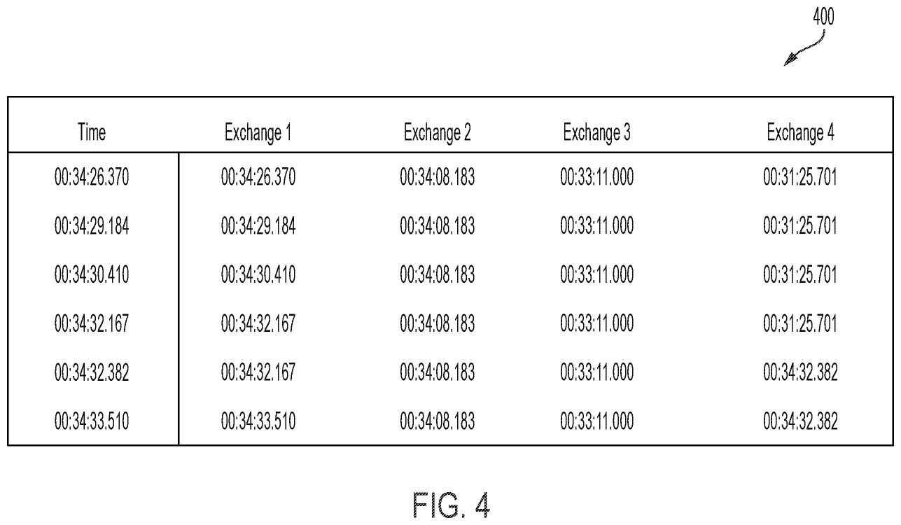

Notably, due to the computational complexity caused inter alia by the amount of raw data to be received and processed, tracking the time lags since the most recent trade on each exchange requires high-performance computing systems and high-throughput/low latency communication channels that are capable of facilitating near real-time computations. In the present example, the relevant portion of example data utilized for tracking the most recent trades is shown in table 400 of FIG. 4. As shown in FIG. 4, Exchange 4 had the most recent trade (at 00:34.32.382) and therefore at that point in time its VAS score has decayed less than the VAS scores of other exchanges.

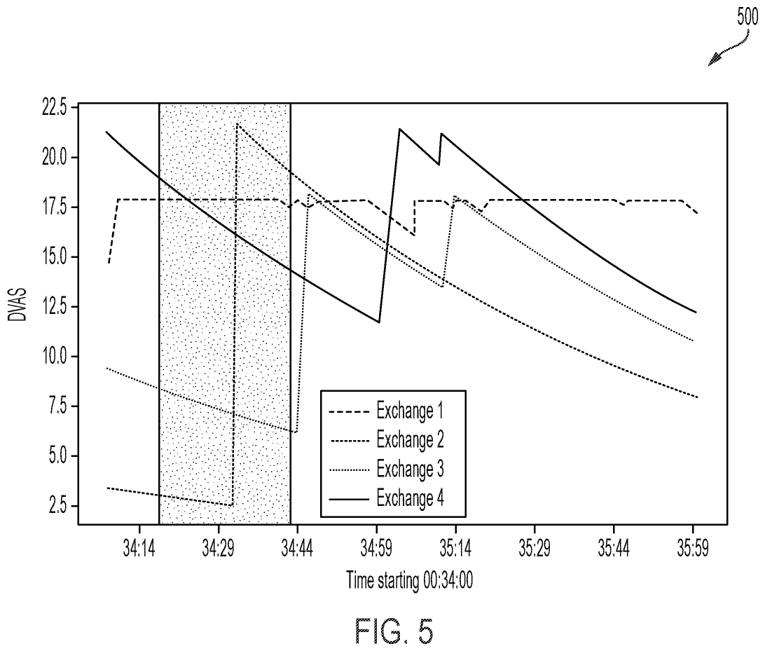

FIG. 5 shows graphs that schematically illustrate the DVAS scores for each of the four exchanges within the period of time shown in table 400 of FIG. 4. As seen from FIGS. 4-5, at 00:34.32.167 minutes after midnight Exchange 1 had the most recent trade. Then, at 00:34.32.382, Exchange 4 had the most recent trade and therefore decayed less than the other exchanges at that point. Vertical discontinuity indicates arrival of new data (i.e., a fresh trade) and resets the DVAS for that exchange. When there are no trades, the DVAS decays. Exchange 4 shows the highest DVAS (between 20.0 and 22.5) at 34:33 and the least decay relative to the other exchanges at that point which was the freshest piece of data. This is due to the fact that no other trades arrived between that point and the period end time of 35:00 minutes after midnight.

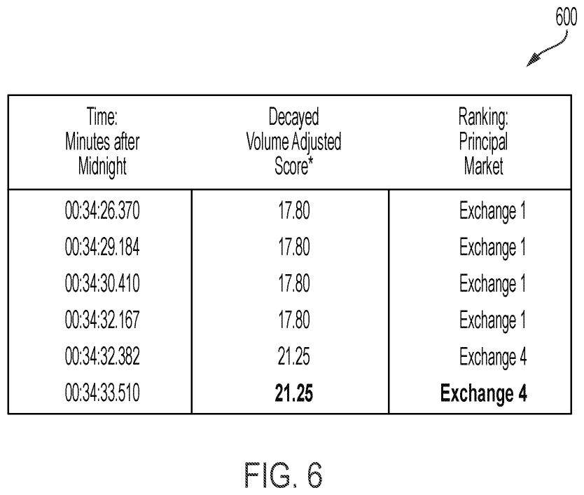

The exchanges are ranked based on their respective DVAS scores and the highest-ranking exchange is designated as the principal market for that point in time. Table 600 of FIG. 6 shows the principal market for several points in time leading to 00:35 (“the market closing time” in this Example). As seen from table 600, Exchange 4 is designated as the principal exchange as of 00:34.33:510.

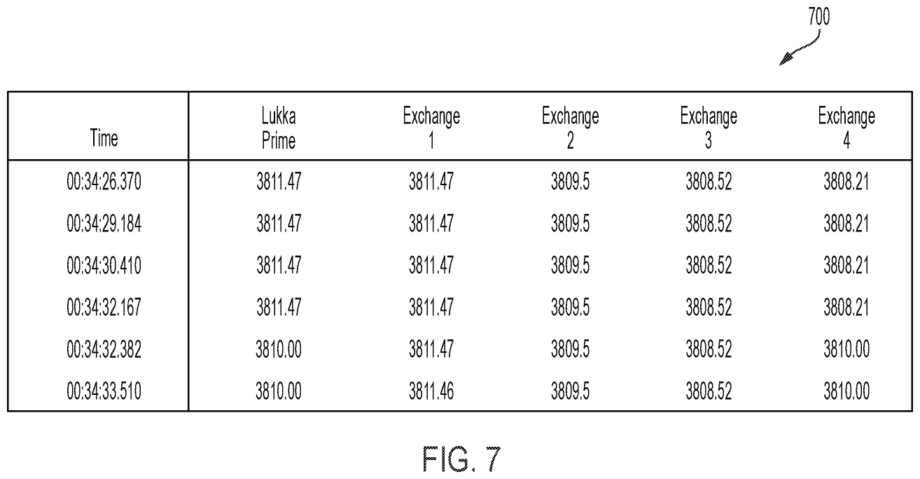

The price of the most recent transaction on the principal market is designated as the fair value of the cryptocurrency at that point of time. As schematically illustrated by table 700 of FIG. 7, the spot price on Exchange 4 at 34:33.510 is $3,810, which represents the fair value of the cryptocurrency extracted from minutes after midnight at the end of the reporting period that is being considered (e.g., a quarter).

This valuation can be used for accounting and reporting purposes. In an illustrative example, the valuation can be used to measure the investment in cryptocurrencies on the report for the reporting period. In another illustrative example, the valuation can be used for computing gains or losses on associated with a given set of cryptocurrency transactions.

An example computing system implementing the systems and methods described herein may receive transaction records related to cryptocurrency trades and transfers performed by a single person (e.g., a natural person or a corporation) or a group of affiliated persons via one or more cryptocurrency accounts associated with one or more cryptocurrency trading platforms. The raw set of transaction records may be received from the cryptocurrency trading platforms and/or from one or more customer accounting platforms.

The computing system may then parse the received raw transaction records. Based on the extracted transaction information, the computing system may determine the transaction types, amounts, currencies, timestamps, and other relevant information carried by the transaction records being analyzed. In various illustrative examples, the transaction types include: acquisition transactions, disposal transactions, deposit transactions, withdrawal transaction, fee payment transactions, and/or various other types.

The computing system may then assign each transaction record to one or more accounting perimeters (formed, e.g., by accounts, sub-accounts, and/or other transaction attributes). The computing system may process the transactions within each accounting perimeter, such that one or more acquisition transactions would be matched to each disposal transaction (e.g., such that the total amount of the chosen acquisition transactions is equal to the amount of the matched disposal transaction). For each disposal transaction and the matched acquisition transactions, the computing system may compute the resulting gain or loss based on the cryptocurrency valuation produced by the systems and methods described herein.

The gain/loss computation may involve determining, for each of the matched disposal and acquisition transactions, the transaction amount in a chosen fiat currency (e.g., U.S. dollars) or in another cryptocurrency based on the historic price of the cryptocurrency which has been acquired or disposed by the transaction. “Historic price” herein shall refer to the price which was effective at the time of performing the corresponding disposal or acquisition transaction. The historic price of the cryptocurrency as of a certain date and time can be determined using the cryptocurrency valuation methods described herein (e.g., example method 100 of cryptocurrency valuation by processing near real-time and historical data from multiple cryptocurrency exchanges).

Upon determining the historic price-based transaction amounts in the chosen fiat currency, the computing system implementing the methods described herein may compute, for each disposal transaction and the matched acquisition transactions, the resulting gain or loss, by summing up the fiat currency amount of the disposal transaction and the fiat currency amounts of the matched acquisition transactions, such that a positive result would indicate a gain while a negative result would indicate a loss (assuming that the disposal transaction amount is positive, while acquisition transaction amounts are negative).

Notably, due to the computational complexity caused inter alia by the amount of raw data to be received and processed, computing the gains and losses requires high-performance computing systems and high-throughput/low latency communication channels that are capable of facilitating near real-time computations.

The computed gains or losses for the matched transactions, as well as other relevant data, may be summarized in one or more reports of various fixed or user-defined formats. The reports may be visually rendered via a graphical user interface (GUI), saved to one or more files, and/or printed. In an illustrative example, the reports may be formatted for rendering via a GUI of a portable computing device (such as a smartphone or a tablet).

In some implementations, the computing system implementing the methods described herein may utilize the computed gain or losses, as well as other relevant data, for producing one or more electronic tax accounting forms, which may be reviewed and electronically signed by the user. Upon obtaining the user's electronic signature, the computing system may upload the electronic tax accounting forms to a server of a government agency which is authorized to accept electronic tax form filings.

FIG. 8 depicts a component diagram of an example computing system which may be employed for implementing the methods described herein. The computing system 1000 may be connected to other computing system in a LAN, an intranet, an extranet, or the Internet. The computing system 1000 may operate in the capacity of a server or a client computing system in client-server network environment, or as a peer computing system in a peer-to-peer (or distributed) network environment. The computing system 1000 may be a provided by a personal computer (PC), a tablet PC, a set-top box (STB), a Personal Digital Assistant (PDA), a cellular telephone, or any computing system capable of executing a set of instructions (sequential or otherwise) that specify operations to be performed by that computing system. Further, while only a single computing system is illustrated, the term “computing system” shall also be taken to include any collection of computing systems that individually or jointly execute a set (or multiple sets) of instructions to perform any one or more of the methods described herein.

Exemplary computing system 1000 includes a processor 1002, a main memory 1004 (e.g., read-only memory (ROM) or dynamic random access memory (DRAM)), and a data storage device 1018, which communicate with each other via a bus 1030.

Processor 1002 may be represented by one or more general-purpose processing devices such as a microprocessor, central processing unit, or the like. More particularly, processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 1002 may also be one or more special-purpose processing devices such as an application specific integrated circuit (ASIC), a field programmable gate array (FPGA), a digital signal processor (DSP), network processor, or the like. Processor 1002 is configured to execute instructions 1026 for performing the methods described herein.

Computing system 1000 may further include a network interface device 1022, a video display unit 1010, a character input device 1012 (e.g., a keyboard), and a touch screen input device 1014.

Data storage device 1018 may include a computer-readable storage medium 1024 on which is stored one or more sets of instructions 1026 embodying any one or more of the methods or functions described herein. Instructions 1026 may also reside, completely or at least partially, within main memory 1004 and/or within processor 1002 during execution thereof by computing system 1000, main memory 1004 and processor 1002 also constituting computer-readable storage media. Instructions 1026 may further be transmitted or received over network 1016 via network interface device 1022.

In an illustrative example, instructions 1026 may include instructions of method 100 of cryptocurrency valuation by processing near real-time and historical data from multiple cryptocurrency exchanges, implemented in accordance with one or more aspects of the present disclosure. While computer-readable storage medium 924 is shown in the example of FIG. 9 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methods of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, graphemes, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing system, or similar electronic computing system, that manipulates and transforms data represented as physical (e.g., electronic) quantities within the computing system's registers and memories into other data similarly represented as physical quantities within the computing system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
assigning, by a computing system, to each exchange of a plurality of exchanges trading in a specified cryptocurrency, a Base Exchange Score (BES) reflecting one or more characteristics of the exchange;
computing, by the computing system, for each exchange of the plurality of exchanges, a Volume Adjusted Score (VAS) by adjusting the BES based on a relative volume of transactions serviced by the exchange during a predefined period of time;
computing, by the computing system, for each exchange of the plurality of exchanges, a Decayed Volume Adjusted Score (DVAS) by adjusting the VAS of the exchange to reflect a period of time passed since a most recent transaction performed on the exchange with respect to the specified cryptocurrency;
ranking, by the computing system, the plurality of exchanges by their respective DVAS scores;
designating, by the computing system, an exchange associated with a highest value of the DVAS as a principal market for the specified cryptocurrency at a specified point in time; and
designating, by the computing system, a price of a most recent transaction on the principal market as representing a fair value of the specified cryptocurrency at the specified point in time.

2. The method of claim 1, wherein the characteristics of the exchange comprise a level of oversight reflecting regulations and rules applicable to the exchange.

3. The method of claim 1, wherein the characteristics of the exchange comprise microstructure efficiency reflecting an effective bid-ask spread of the exchange.

4. The method of claim 1, wherein the characteristics of the exchange comprise data transparency reflecting a level of detail of data provided by the exchange.

5. The method of claim 1, wherein the characteristics of the exchange comprise data integrity reflecting at least one of: order reconstruction, minute volume matching, or daily volume matching of the exchange.

6. The method of claim 1, wherein computing the DVAS is performed by applying an exponential multiplier with a negative decay factor reflecting the period of time passed since the most recent transaction performed on the exchange with respect to the specified cryptocurrency.

7. The method of claim 1, further comprising:
generating a report reflecting the fair value of the specified cryptocurrency.

8. The method of claim 1, further comprising:
computing, based on the fair value of the specified cryptocurrency, a gain or a loss associated with a cryptocurrency disposal transaction and one or more matched cryptocurrency acquisition transactions with respect to the specified cryptocurrency.

9. The method of claim 8, further comprising:
generating an electronic tax accounting form reflecting the gain or the loss associated with the specified cryptocurrency;
responsive to receiving, via a graphical user interface, an approval of the electronic tax accounting form, digitally signing the electronic tax accounting form; and
uploading the electronic tax accounting form to a server authorized to accept electronic tax form filings.

10. A system, comprising:
a memory; and
a processor, coupled to the memory, wherein the processor is configured to:
assign, to each exchange of a plurality of exchanges trading in a specified cryptocurrency, a Base Exchange Score (BES) reflecting one or more characteristics of the exchange;
compute, for each exchange of the plurality of exchanges, a Volume Adjusted Score (VAS) by adjusting the BES based on a relative volume of transactions serviced by the exchange during a predefined period of time;
compute, for each exchange of the plurality of exchanges, a Decayed Volume Adjusted Score (DVAS) by adjusting the VAS of the exchange to reflect a period of time passed since a most recent transaction performed on the exchange with respect to the specified cryptocurrency;
rank the plurality of exchanges by their respective DVAS scores;
designate an exchange associated with a highest value of the DVAS as a principal market for the specified cryptocurrency at a specified point in time; and
designate a price of a most recent transaction on the principal market as representing a fair value of the specified cryptocurrency at the specified point in time.

11. The system of claim 10, wherein the characteristics of the exchange comprise at least one of: a level of oversight reflecting regulations and rules applicable to the exchange, microstructure efficiency reflecting an effective bid-ask spread of the exchange, data transparency reflecting a level of detail of data provided by the exchange, or daily volume matching of the exchange.

12. The system of claim 10, wherein computing the DVAS is performed by applying an exponential multiplier with a negative decay factor reflecting the period of time passed since the most recent transaction performed on the exchange with respect to the specified cryptocurrency.

13. The system of claim 10, wherein the processor is further configured to: generate a report reflecting the fair value of the specified cryptocurrency.

14. The system of claim 10, wherein the processor is further configured to:
computing, based on the fair value of the specified cryptocurrency, a gain or a loss associated with a cryptocurrency disposal transaction and one or more matched cryptocurrency acquisition transactions with respect to the specified cryptocurrency.

15. A non-transitory computer-readable storage medium comprising executable instructions that, when executed by a computing system, cause the computing system to:
assign, to each exchange of a plurality of exchanges trading in a specified cryptocurrency, a Base Exchange Score (BES) reflecting one or more characteristics of the exchange;
compute, for each exchange of the plurality of exchanges, a Volume Adjusted Score (VAS) by adjusting the BES based on a relative volume of transactions serviced by the exchange during a predefined period of time;
compute, for each exchange of the plurality of exchanges, a Decayed Volume Adjusted Score (DVAS) by adjusting the VAS of the exchange to reflect a period of time passed since a most recent transaction performed on the exchange with respect to the specified cryptocurrency;
rank the plurality of exchanges by their respective DVAS scores;
designate an exchange associated with a highest value of the DVAS as a principal market for the specified cryptocurrency at a specified point in time; and
designate a price of a most recent transaction on the principal market as representing a fair value of the specified cryptocurrency at the specified point in time.

16. The non-transitory computer-readable storage medium of claim 15, wherein the characteristics of the exchange comprise at least one of: a level of oversight reflecting regulations and rules applicable to the exchange, microstructure efficiency reflecting an effective bid-ask spread of the exchange, data transparency reflecting a level of detail of data provided by the exchange, or daily volume matching of the exchange.

17. The non-transitory computer-readable storage medium of claim 15, wherein computing the DVAS is performed by applying an exponential multiplier with a negative decay factor reflecting the period of time passed since the most recent transaction performed on the exchange with respect to the specified cryptocurrency.

18. The non-transitory computer-readable storage medium of claim 15, further comprising executable instructions that, when executed by the computing system, cause the computing system to:
generate a report reflecting the fair value of the specified cryptocurrency.

19. The non-transitory computer-readable storage medium of claim 15, further comprising executable instructions that, when executed by the computing system, cause the computing system to:
compute, based on the fair value of the specified cryptocurrency, a gain or a loss associated with a cryptocurrency disposal transaction and one or more matched cryptocurrency acquisition transactions with respect to the specified cryptocurrency.

20. The non-transitory computer-readable storage medium of claim 19, further comprising executable instructions that, when executed by the computing system, cause the computing system to:
generate an electronic tax accounting form reflecting the gain or the loss associated with the specified cryptocurrency;
responsive to receiving, via a graphical user interface, an approval of the electronic tax accounting form, digitally sign the electronic tax accounting form; and
upload the electronic tax accounting form to a server authorized to accept electronic tax form filings.
